(19) United States
(12) Patent Application Publication
(10) Pub. No.: US 2020/0379379 A1
(43) Pub. Date: Dec. 3, 2020

(54) FIXING APPARATUS AND FIXING METHOD

(71) Applicant: Konica Minolta, Inc., Tokyo (JP)

(72) Inventors: Tomoo SAKIMURA, Tokyo (JP); Izumi MUKOYAMA, Tokyo (JP)

(21) Appl. No.: 16/871,232

(22) Filed: May 11, 2020

(30) Foreign Application Priority Data
May 28, 2019 (JP) 2019-099209

(51) Int. Cl. G03G 15/20

(52) U.S. Cl. CPC G03G 15/206

(57) ABSTRACT

Provided is a fixing apparatus including a fixing member, wherein the fixing member includes a thermoplastic resin layer as an outermost surface layer; and the fixing apparatus includes an indentation forming member having a protrusion structure with no angular part formed on a surface for forming U-shaped indentations on the outermost surface layer by applying pressure on the fixing member.

### CROSS-REFERENCE TO RELATED APPLICATIONS

The entire disclosure of Japanese Patent Application No. 2019-099209 filed on May 28, 2019 is incorporated herein by reference in its entirety.

### BACKGROUND

### Technological Field

The present invention relates to a fixing apparatus and a fixing method. More specifically, the present invention relates to a fixing apparatus and a fixing method excellent in separability between a fixing member and a toner image when forming an image and capable of acquiring a high-quality toner image.

### Description of the Related Art

Conventionally, there is known an electrophotographic image forming apparatus that forms a toner image by developing an electrostatic latent image formed on a photosensitive drum with a toner, transfers the formed toner image on a recording sheet, and fixes the transferred toner image by applying heat to form an image on the recording sheet.

As for the electrophotographic members constituting such electrophotographic image forming apparatus, it is often required to have releasability on the surface thereof. Examples of such members may be a photoreceptor that is required to have transferability and cleanability of the toner, an intermediate transfer member that is required to have transferability of the toner, and a fixing member that is required to have separability of media on which the fused toner is attached. Among those, a demand for giving releasability to the fixing member is prominent because the fused toner has viscosity.

In the fixing apparatus, the heated fixing member and the medium on which the toner has already been transferred are press-fitted, and the toner is fixed on the medium by heating and pressurization processing. In a latter step, it is necessary to separate the fixing member and the medium.

In order to secure the separability between the fixing member and the medium, tetrafluoroethylene perfluoroalkylvinylether copolymer (PFA) is broadly used nowadays as the surface layer of the fixing member. In addition, taking supplementary means such as a separator claw, suctioning the medium, spraying air to the head part of the medium increases the separability.

However, with the currently applied fixing method, it is still insufficient for fulfilling the demands such as enabling still higher-rate printing in future, reducing the supplementary means for saving the energy and the cost, and expanding the types of media such as non-stiff thin paper that is hard to be separated. In addition, in order to cut the downtime of the machine that is directly related to lose customers, it is desired to make the member permanent. In view of such circumstances, it has been tried to refine the surface layer of the fixing member for increasing the separability between the fixing member and the medium.

For such problem, as a method for fabricating a fixing roll configuring a fixer, there is disclosed a method for coating a fluorine based resin on a cylindrical or columnar base material, with which a fluorine-based resin layer is pressurized between the base material and a surface transfer member provided on the outer side of the fluorine-based resin layer at the time of heating and firing the fluorine-based resin to form minute uneven shapes on the surface of the surface transfer member on the surface of the fluorine-based resin layer (for example, see JP 9-277378A). The proposed method claims to be able to form a stable fluorine-based resin coating with desired surface roughness on the fixing base material.

However, there is no method at all mentioned in JP 9-277378A for forming the uneven shapes using an indentation forming member. Further, the method disclosed in JP 9-277378A is related to giving roughness on the surface at the stage of manufacturing the fixing member but not related to the mechanism of the fixing apparatus. Further, the rough structure formed on the surface of the fixing member configured with a thermoplastic resin has low durability since the minute uneven structure gradually disappears by being exposed to the heat and pressure in the fixing steps when the fixing member is repeatedly used.

Further, there is also disclosed a fixing apparatus including: a fixing member; a pressure member that forms a fixing nip by being pressed against the fixing member; a rotatable roughening member with a top surface layer uniformly having a specific size of abrasive grains formed on a circumference of the fixing member for roughening the fixing member; and detachable means capable of making the roughening member to approach and separate with respect to the fixing member, in which the fixing member is roughened by the roughening member before fixing when a transfer material is cardboard (for example, see JP 2009-294453A). This method claims to be able to overcome such a problem that scratches, separator claw marks, and the like on the surface of a fixing roller caused by paper become conspicuous on images as gloss unevenness when fixing the cardboard.

However, there is no method mentioned at all in JP 2009-294453A for forming the uneven shapes using the indentation forming member. Further, the method disclosed in JP 2009-294453A is a method that makes a great number of abrasions over already existing scratches, and is not capable of making smooth and shallow U-shapes. Further, this method is a method scraping the surface layer of the fixing member, so that the life of the fixing member is shortened and it is concerned that separability and the image quality may be deteriorated by the toner component embedded in the scratches.

### SUMMARY

The present invention is designed in view of the aforementioned problems, and the object thereof is to provide a fixing apparatus and a fixing method excellent in separability between a fixing member and a toner image and capable of acquiring a high-quality toner image when forming the image.

As a result of intensive investigations in view of the forgoing object, it is found that a fixing apparatus according to the present invention exhibits excellent separability between a fixing member and a toner image at the time of forming the image and is capable of acquiring the high-quality toner image. The fixing apparatus according to the present invention includes a fixing member, wherein the fixing member includes a thermoplastic resin layer as an outermost surface layer; and the fixing apparatus includes an indentation forming member having a protrusion structure with no angular part formed on a surface for forming U-shaped indentations on the outermost surface layer by applying pressure on the fixing member.

That is, the problems of the present invention can be overcome with the following means.

To achieve at least one of the abovementioned objects, the fixing apparatus reflecting one aspect of the present invention is a fixing apparatus including a fixing member, wherein: the fixing member includes a thermoplastic resin layer as an outermost surface layer; and the fixing apparatus includes an indentation forming member having a protrusion structure with no angular part formed on a surface for forming U-shaped indentations on the outermost surface layer by applying pressure on the fixing member.

To achieve at least one of the abovementioned objects, a fixing method reflecting another aspect of the present invention is a fixing method that fixes a toner image by using the fixing apparatus.

The technical feature of the fixing member configured in the manner defined in the present invention and implementing mechanism of the effects thereof are surmised as follows.

In the fixing apparatus of the present invention, the indentation forming member having the protrusion structure is press-fitted to the surface of the fixing member having the thermoplastic resin layer on the surface layer as the member for fixing the toner in order to form the recessed structure on the outermost surface layer of the fixing member. Thereby, separability between the fixing member and the toner image can be improved at the time of forming the image.

The indentation forming member of the present invention is driven or press-fitted driven at an equal circumferential speed with respect to the fixing member such as an endless-type belt, a roller, or the like for fixing the toner, and includes the protrusion structure having no angular part such as no sharp-angled projection on the surface thereof. The indentation forming member press-fits and transfers the protrusion structure to the surface of the fixing member to form a great number of U-shapes having no angular part with smooth surface on the surface of the fixing member. With such configuration, the surface of the fixing member is maintained to have an appropriate surface shape, thereby making it possible to keep high separability with the fixed toner image.

In the present invention, because the recessed structure is formed on the surface of the fixing member by the indentation forming member according to the present invention, the contact area between the fixing member and the surface of the toner fixed at the outlet of the separation nip in a fixing step is reduced and the adhesion force is deteriorated. Thereby, separation is easily promoted. Even though the U-shapes formed on the surface of the thermoplastic resin are gradually deformed and the effects thereof may be lost after repeated use, it is possible to maintain high separability by providing a mechanism for regenerating the U-shapes with an engraving member.

Another feature of the configuration of the fixing apparatus including the indentation forming member according to the present invention is that the qualities other than separability do not deteriorate, either. That is, through engraving a great number of smooth and shallow U-shapes on the surface of the fixing member, it is possible to implement tight fitting in the center of the fixing nip where the pressure is high together with the effect of the elastic layer so that normal fixing can be achieved. If the tight-fitting property with the fixing member is insufficient, the fixing temperature may be increased or images may be roughened. However, such phenomena do not occur with the present invention. Further, the U-shapes of the fixing member are restored at the outlet of the nip where the pressure in the fixing step is reduced, so that separability is improved. The fact that the U-shapes to be engraved are smooth and shallow is also advantageous in terms of cracks and wear of the surface layer as well as sticking and filming of the toner.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic sectional view showing an example of a configuration of a fixing member that has an outermost surface layer configured with a thermoplastic resin according to the present invention;

FIG. 2A and FIG. 2B are schematic views showing an example of a configuration of an endless-belt type fixing member having a thermoplastic resin layer according to the present invention;

FIG. 3A and FIG. 3B are schematic views showing an example of a basic configuration of an indentation forming member having a hemispherical protrusion structure according to the present invention;

FIG. 4A, FIG. 4B, and FIG. 4C are schematic views showing an example of a roller-type indentation forming member (a first embodiment) having a hemispherical protrusion structure according to the present invention;

FIG. 5A and FIG. 5B are schematic views showing an example of a manufacturing method of the roller-type indentation forming member (the first embodiment) having the hemispherical protrusion structure according to the present invention;

FIG. 6A and FIG. 6B are schematic views showing an example of a method for forming U-shaped indentations on the fixing member by using the indentation forming member of the first embodiment;

FIG. 7 is a schematic view showing an example of a configuration of an endless-belt type indentation forming member (a second embodiment) having a hemispherical protrusion structure according to the present invention;

FIG. 8 is a schematic view showing an example of an entire configuration of an image forming apparatus that can be applied to the present invention;

FIG. 9 is a schematic view showing an example of a configuration of a fixing apparatus having the roller-type indentation forming member (the first embodiment) used in the image forming apparatus;

FIG. 10A, FIG. 10B, and FIG. 10C are schematic views for describing the effect of separability in a fixer; and

FIG. 11 is a schematic view showing an example of a configuration of a fixing member having the endless-belt type indentation forming member (the second embodiment) used in the image forming apparatus.

### DETAILED DESCRIPTION OF THE EMBODIMENTS

Hereinafter, embodiments related to a fixing apparatus and a fixing method of the present invention will be described with reference to the accompanying drawings. However, the scope of the invention is not limited to the disclosed embodiments.

The fixing apparatus according to the present invention includes a fixing member having a thermoplastic resin layer as an outermost surface layer, and includes an indentation forming member that has a protrusion structure having no angular part on a surface forming U-shaped indentations on the outermost surface layer by applying pressure on the fixing member.

The above-described feature is a technical feature common to the present invention related to each of the embodiments described hereinafter.

As the embodiments of the present invention, the thermoplastic resin forming the thermoplastic resin layer is preferable to be at least a fluorine-based resin in respect that it is possible to acquire more excellent separability from the viewpoint that the effect as the object of the present invention can be implemented still more.

Further, the indentation forming member is preferable to be a rotation member in respect that it is possible to form the U-shapes continuously on the surface of the fixing member.

Further, the shape of the protrusions of the indentation forming member is preferable to be in a hemispherical protrusion structure in respect that it is possible to provide the surface of the fixing member with excellent separability and to form the recesses having continuous curved faces.

Further, it is preferable for the surface of the indentation forming member to be formed with a material selected from metals, glass, ceramics, and resins in respect that it is possible to provide excellent durability (wear resistance) and to stably form the protrusions of a desired shape.

Further, it is preferable for the indentation forming member to be driven or rotationally driven at an equal circumferential speed with respect to the conveyed fixing member in respect that it is possible to stably form the U-shapes on the surface of the fixing member.

Further, it is preferable for the indentation forming member to be constantly press-fitted to the fixing member in respect that it is possible to prevent the shape of the already-formed recesses from disappearing due to restoration in continuous fixing operations.

Further, it is preferable for the indentation forming member to have a function capable of switching between press-fitting to and isolating from the fixing member in respect that it is possible to prevent deterioration and the like of the fixing member and to fix the toner efficiently by forming the U-shapes on the surface of the fixing member at a necessary timing.

Hereinafter, the fixing apparatus and the fixing method according to the present invention will be described in details with reference to the accompanying drawings. Note that “to” between numerical values showing a range thereof is used in the present application to include the numerical values written before and after thereof as the lower limit value and the upper limit value.

The fixing apparatus of the present invention includes at least the fixing member having a thermoplastic resin layer as the outermost surface layer and the indentation forming member having the protrusion structure with no angular part on the surface for forming U-shaped indentations on the outermost surface layer by applying pressure to the fixing member.

Hereinafter, details of the fixing member and the indentation forming member according to the present invention will be described.

### <<Fixing Member>>

In the present invention, it is preferable for the thermoplastic resin layer forming the outermost surface layer of the fixing member to be at least a fluorine-based resin as a thermoplastic resin. Further, it is preferable for the fixing member according to the present invention to have at least a base material, an elastic layer, and the thermoplastic resin layer in this order.

### [Basic Configuration of Fixing Member]

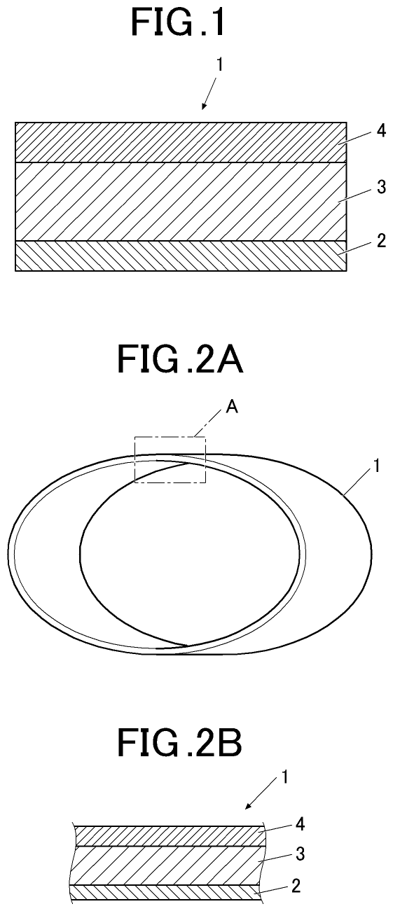

Described is an example of the configuration of the fixing member having the outermost surface layer formed with the thermoplastic resin according to the present invention shown in FIG. 1, which is a case where the fixing member is formed with the base material, the elastic layer, and the thermoplastic resin layer.

The example of a fixing member 1 according to the present invention in FIG. 1 shows a typical configuration having an elastic layer 3 and a thermoplastic resin layer 4 on a base material 2.

An example of the form of the fixing member according to the present invention may be a known fixing member that is a roller type or an endless-belt type in which the outermost surface layer configuring the fixing member is the thermoplastic resin layer.

The form of the fixing member according to the present invention in a case of the roller-type fixing member, for example, is a fixing sleeve in which the elastic layer 3 and the thermoplastic resin layer 4 are held on a metallic cylindrical outer peripheral surface.

FIG. 2A and FIG. 2B show an example of the configuration of the endless-belt type fixing member having the thermoplastic resin layer according to the present invention.

FIG. 2A is a schematic view showing an example of the configuration of the endless-belt type fixing belt 1 having the thermoplastic resin layer according to the present invention, and FIG. 2B is an enlarged schematic sectional view of an area A of the fixing belt 1 shown in FIG. 2A.

As shown in FIG. 2B, the fixing belt 1 is an endless belt formed by stacking the base material 2, the elastic layer 3, and the thermoplastic resin layer 4 in this order.

Note that the fixing member may have an adhesive layer exhibiting an adhesive function formed between the elastic layer and the outermost surface layer.

### [Constituent Materials of Fixing Member]

Hereinafter, details of the base material, the elastic layer, and the outermost surface layer configuring the fixing member will be described.

### [Base Material]

In the case of the endless-belt type fixing member, for example, the base material 2 configuring the fixing member is formed with a flexible resin exhibiting heat resistance (heat-resistant resin). Note that “heat resistance” in the present invention means to exhibit a sufficiently stable prescribed property without being deformed in electrophotographic image formation under temperatures such as a range of temperatures 150 to 220° C. when the fixing member is used for fixing toner images on a recording medium.

The heat-resistant resin is selected as appropriate from resins that exhibit no substantial degeneration and deformation at the use temperatures of the fixing member, and it is possible to use a single kind or to use two or more kinds together.

Examples of the heat-resistant resin that can be applied to the present invention may be polyphenylene sulfide, polyarylate, polysulfone, polyethersulfone, polyetherimide, polyimide, polyamideimide, and polyetheretherketone. Among those, polyimide is preferable in terms of the heat resistance.

Polyimide can be acquired by heating polyamic acid as a precursor thereof at 200° C. or higher or by promoting dehydration and cyclization (imidization) reactions using a catalyst, for example. Polyamic acid may be produced by dissolving tetracarboxylic dianhydride and a diamine compound in a solvent and by mixing and applying heat to promote a polycondensation reaction, or a product on the market may be used. Examples of tetracarboxylic dianhydride and diamine compounds may be the compounds mentioned in paragraphs [0123] to of JP 2013-25120A.

The heat-resistant resin is a main material for configuring the base material of the fixing member according to the present invention, and the content thereof may simply need to be sufficient to form the base material. The content of the heat-resistant resin in the base material is preferable to be 40 to 100 volume % of the entire volume of the base material in terms of the formability at the time of fabricating the base material.

The base material 2 may further contain components other than the heat-resistant resin in a range with which the effect as the object of the present invention can be achieved. For example, as a constituent material of the base material, a filler may be contained in addition to the heat-resistant resin. The filler may be a component that contributes to improve at least one of the performances such as hardness, heat transferability, and conductivity of the base material. The filler may be of a single kind or two or more kinds, and examples thereof may be carbon black, ketjen black, nanocarbon, and graphite.

In the present invention, the fixing property and separability of the fixing member may be deteriorated because the toughness of the base material becomes lowered when the content of the filler in the base material is too large, while a desired effect of the filler such as giving appropriate conductivity may become insufficient when the content is too small. In this viewpoint, it is preferable for the content of the filler in the base material to be 3 mass % or more, more preferable to be 4 mass % or more, and still more preferable to be 5 mass % or more. Further, in the viewpoint described above, it is preferable for the upper limit of the content of the filler in the base material to be 30 mass % or less, more preferable to be 20 mass % or less, and still more preferable to be 10 mass % or less.

### [Elastic Layer]

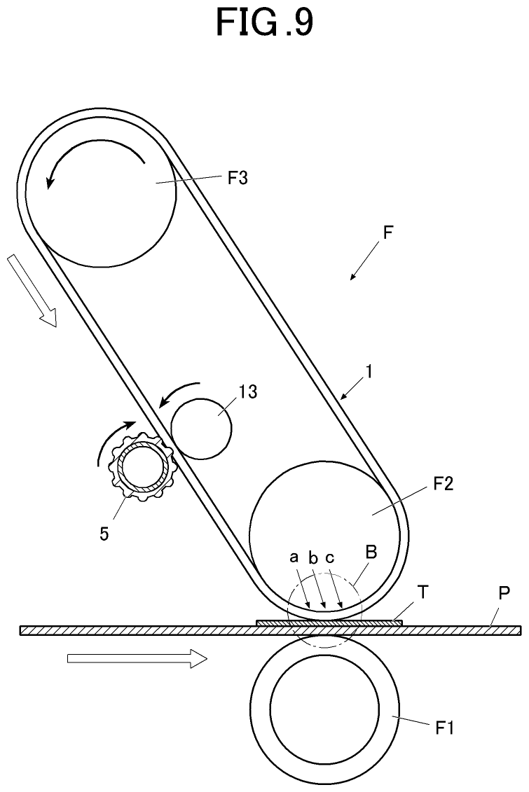

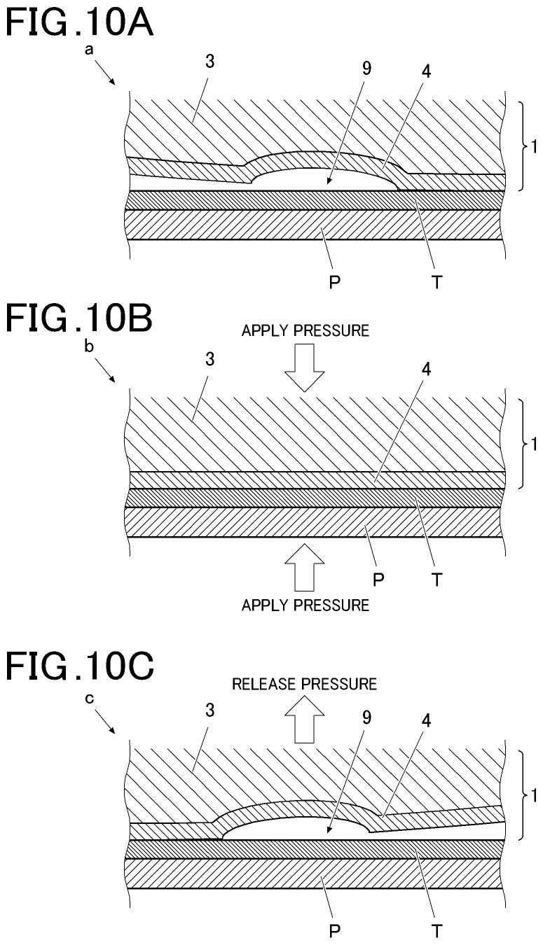

The elastic layer 3 configuring the fixing member 1 according to the present invention is a layer exhibiting elasticity that contributes to improve the contact property between the surface of the fixing member 1 in a fixing nip part (B area shown in FIG. 9) and a recording medium P that carries an unfixed toner image T, and is configured with an elastic material, for example.

Examples of the elastic material that can be applied to the present invention may be elastic resin materials, including silicone rubber, thermoplastic elastomer, and a lubber material. Among those, the elastic material is preferable to be silicone rubber in terms of the heat resistance in addition to the prescribed elastic property.

As for the silicone rubber, it is possible to use a single kind or to use two or more kinds together. Examples of the silicone rubber that can be applied to the present invention may be polyorganosiloxane or a heat cured product thereof, and addition-reaction silicone rubber mentioned in JP 2009-122317A.

An example of the polyorganosiloxane may be dimethylpolysiloxane having both ends blocked by a trimethylsiloxane group and having a vinyl group in its side chain, which is mentioned in JP 2008-255283A.

The thickness of the elastic layer 3 is preferable to be within a range of 5 to 500 μm and more preferable to be within a range of 50 to 350 μm in order to sufficiently implement the heat transferability and elasticity, for example.

The elastic layer 3 may further contain a component other than the elastic resin materials described above within a range with which the effect as the object of the present invention can be acquired. For example, the elastic layer may contain a thermal conductive filler for improving the heat transferability of the elastic layer in addition to the elastic material. Examples of the material of the filler include silica, metallic silicon, alumina, zinc, aluminum nitride, boron nitride, silicon nitride, silicon carbide, carbon, and graphite. The form of the filler is not limited but may be in a form of spherical power, irregular powder, flat powder, or fiber, for example.

The content of the elastic resin material in the elastic material configuring the elastic layer is preferable to be within a range of 60 to 100 volume % with respect to the entire volume of the elastic layer, more preferable to be 75 to 100 volume %, and still more preferable to be 80 to 100 volume % in order to implement both the heat transferability and elasticity.

### [Thermoplastic Resin Layer: Outermost Surface Layer]

In the thermoplastic resin layer configuring the outermost surface layer (also simply referred to as the outermost surface layer hereinafter) of the fixing member of the present invention, one of the thermoplastic resins is preferable to be a fluorine-based resin.

### (Thermoplastic Resin)

In the present invention, there is no specific limit set for the thermoplastic resin configuring the outermost surface layer of the fixing member as long as it has necessary heat resistance and releasability, and examples thereof may be vinyl-based thermoplastic resins (for example, polyvinyl chloride, polyvinylidene chloride, and polyvinyl alcohol), polystyrene-based thermoplastic resins (for example, polystyrene, a styrene-acrylonitrile copolymer, an acrylonitrile-butadiene-styrene copolymer (ABS), polyethylene, an ethylene-vinyl acetate copolymer), polypropylene, polyacetal, acryl-based thermoplastic resins (for example, polymethyl methacrylate, and a methacryl-styrene copolymer), polycarbonate, polyamide-based thermoplastic resins, polyurethane-based thermoplastic resins, fluorine-based thermoplastic resins (for example, trifluorochloroethylene (PCTFE), tetrafluoroethylene (PTFE), a tetrafluoroethylene-hexafluoropropylene copolymer (FEP), a tetrafluoroethylene-ethylene copolymer (ETFE), perfluoroalkoxy alkane (PFA), and a perfluoropolyether compound (PFPE)).

As for the heat resistance required for the thermoplastic resin, it is especially preferable to use the fluorine-based resin because high releasability is required under a continuous condition at about 150° C. or higher in view of low-temperature fixation of the toner.

### (Fluorine-Based Resin)

In the thermoplastic resin layer according to the present invention, the thermoplastic resin is preferable to be a fluorine-based resin. As described above, examples of the fluorine-based resin may be perfluoroalkoxy alkane (PFA), a tetrafluoroethylene-hexafluoropropylene copolymer (FEP), a tetrafluoroethylene-ethylene copolymer (ETFE), and a perfluoropolyether compound (PFPE). More preferably, it is defined as perfluoroalkoxy alkane (PFA) that is a copolymer of tetrafluoroethylene and perfluoroalkoxyethylene. Specifically, it is a film-like or a tubular perfluoroalkoxy alkane (PFA), and it is possible to employ soft PFA manufactured by Chemorous-Mitsui Fluoroproducts Co., Ltd. that is shaped into a tubular shape.

### [Indentation Forming Member]

The fixing apparatus of the present invention includes the indentation forming member having a protrusion structure with no angular part on the surface that forms U-shaped indentations on the outermost surface layer by applying a pressure to press-fit to the fixing member having the thermoplastic resin layer.

A rotation member is a preferable form as the indentation forming member according to the present invention, so that it is possible to form U-shaped indentations on the fixing member efficiently by rotating the indentation forming member in association with drive of the fixing member such as a seamless-belt type endless belt.

In the present invention, the protrusions of the indentation forming member are in the protrusion structure having no angular part on the surface thereof. The protrusion structure having no angular part on the surface according to the present invention is a shape having a continuous curvature surface with no angular part, specifically with no acute-angular part, and preferable to be a three-dimensional structure such as a perfect hemisphere or an elliptical hemisphere.

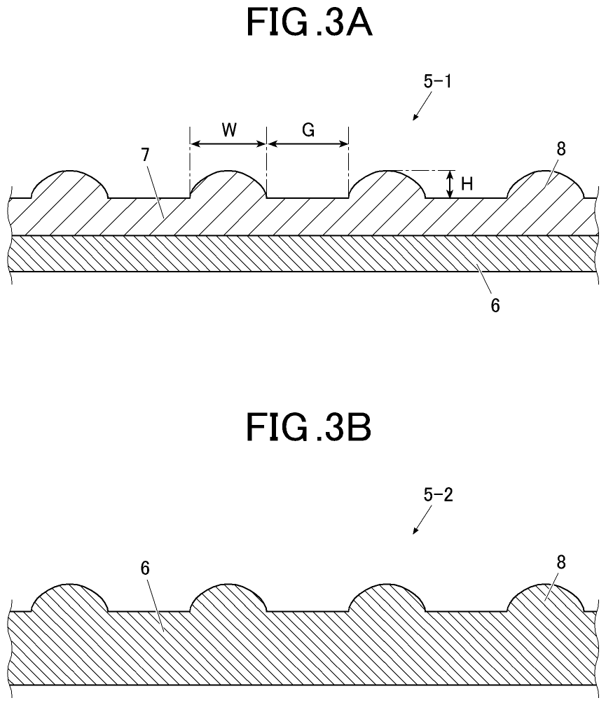

FIG. 3A and FIG. 3B show an example of the basic configuration of the indentation forming member having a hemispherical protrusion structure according to the present invention.

An indentation forming member 5 shown in FIG. 3A is a configuration in which a coating layer 7 is formed on a base material 6, and a plurality of hemispherical protrusions 8 having a continuous curvature surface with no angular part on its surface are provided on the surface of the coating layer 7. While there is no specific limit set for the constituent material of the protrusions, it is preferable to be formed with a material selected from metals, glass, ceramics, and resins.

In the indentation forming member 5 according to the present invention, the base material 6, the coating layer 7, and the protrusions 8 may be formed with materials different from each other. Further, the same material may be used for the constituent material for all of those to be manufactured by integral molding.

The protrusion according to the present invention is the protrusion structure in a shape having a continuous curvature surface with no angular part on its surface and, as the form thereof, there is no specific limit set for width W of the protrusions 8 as shown in FIG. 3A. However, it is preferable to be a hemispherical structure such as a perfect hemispherical or elliptical hemispheric structure having the width W within a range of 5 to 200 μm, more preferably within a range of 10 to 200 μm, and still more preferably within a range of 40 to 100 μm. Further, while there is no specific limit set for height H of the protrusions 8, it is preferable to be within a range of 1 to 100 μm, more preferable to be within a range of 1 to 50 μm, still more preferable to be within a range of 5 to 30 μm, and more specifically preferable to be within a range of 10 to 20 μm.

Further, while there is no specific limit set for an interval G between the protrusions 8, it is preferable to be within a range of 20 to 1000 μm, more preferable to be within a range of 50 to 500 μm, and still more preferable to be within a range of 100 to 300 μm.

While the ratio of the width W with respect to the height H of the protrusion 8 (W/H, aspect ratio) is roughly within a range of 2 to 20, preferably within a range of 2 to 10, and more preferably within a range of 4 to 8, it is preferable to be set as appropriate depending on the purpose.

Further, as shown in FIG. 3B, it is possible to employ an integration molding method with which the indentation forming member 5 according to the present invention is formed with the base material 6 alone, and the protrusions 8 may be formed with the same material as that of the base material 6 such as a metallic material.

### First Embodiment: Roller Type

While there is no specific limit set for the shape of the indentation forming member according to the present invention as long as U-shaped indentations can be formed on the outermost surface layer therewith by abutting against the fixing member, it is preferable to be in a cylindrical roller type as one of the forms.

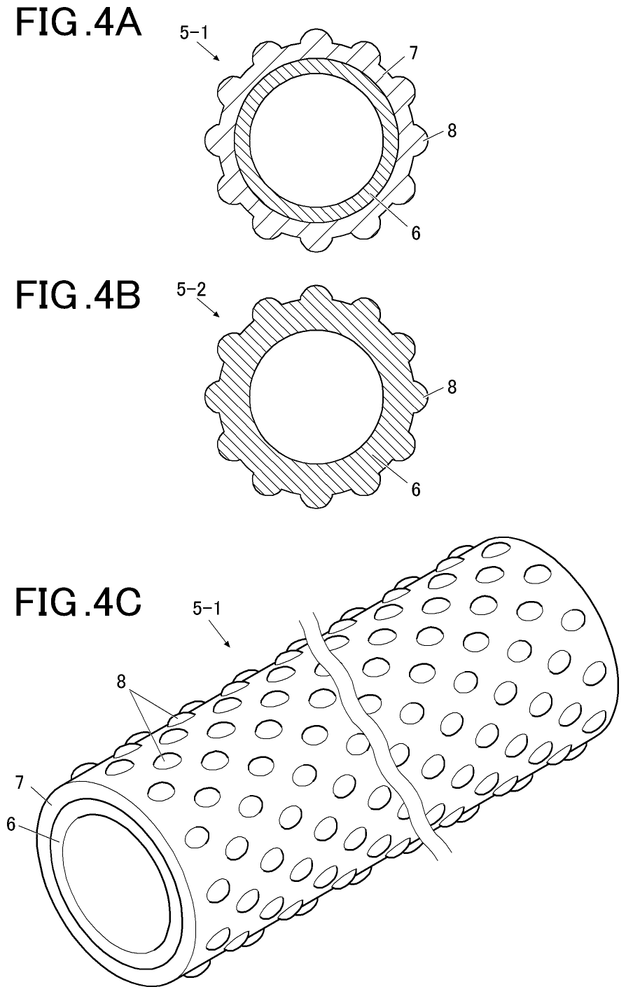

FIG. 4A to FIG. 4C are schematic views showing an example of the roller-type cylindrical indentation forming member having the hemispherical protrusion structure (first embodiment) according to the present invention.

FIG. 4A is a sectional view of the cylindrical indentation forming member 5 corresponding to the configuration of FIG. 3A, in which a hollow cylindrical metallic core bar is used as the base material 6 and the coating layer 7 having a great number of protrusions 8 on its surface is formed in the outer periphery of the core bar.

Further, the cylindrical indentation forming member 5 shown in FIG. 4B is a sectional view of the cylindrical indentation forming member 5 corresponding to the configuration of FIG. 3B, in which the base material 6 and the protrusions 8 are formed by integral molding by using a same single material such as a metallic material.

FIG. 4C is a perspective view of the indentation forming member 5 shown in FIG. 4A described above.

Next, an example of a manufacturing method of the cylindrical roller-type indentation forming member will be described.

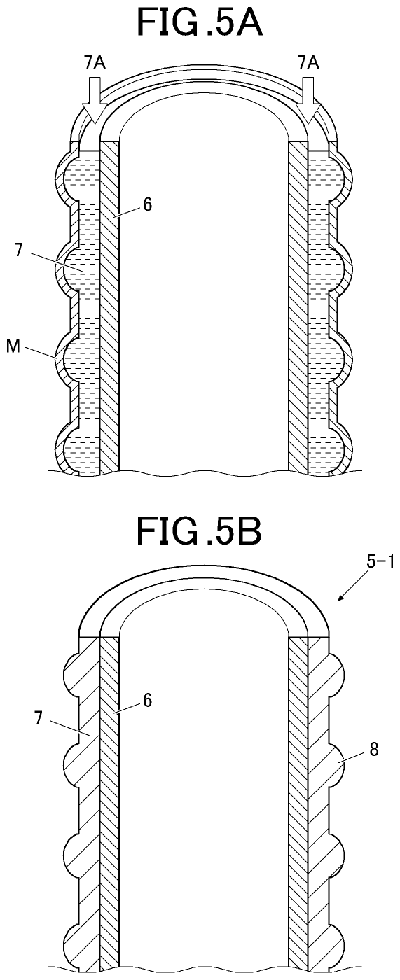

FIG. 5A and FIG. 5B are schematic views showing an example of the manufacturing method of the roller-type indentation forming member having the hemispherical protrusion structure according to the present invention described in FIG. 4A and FIG. 4C, which is a case of employing an integral molding method that uses a same material for the coating layer 7 and the protrusions 8.

As shown in FIG. 5A, a mask member M having a recessed structure of a prescribed pattern with respect to the inner face of the metallic core bar, for example, is placed on the outer periphery of the base material 6 such as the metallic cylindrical core bar with a gap corresponding to the film thickness of the coating layer 7 provided therebetween. Into the formed gap, the material such as a resin material for forming the coating layer 7 and the protrusions 8 is injected, and curing treatment of the injected resin material (for example, heat treatment or ultraviolet irradiation) is performed to cure the coating layer 7 and the protrusions 8.

Then, after confirming that curing is completed to have desired hardness, the mask member M is removed to acquire the indentation forming member 5 having a great number of protrusions 8 on the surface thereof as shown in FIG. 5B.

Further, as other methods for forming the protrusions 8 on the coating layer 7, examples thereof may be a molding method using inkjet printing, a method for forming an embossed part on a roller surface described in JP 2010-94679A, a mat processing method by blasting processing performed on the coating layer, emboss processing for physically forming a wrinkled structure on the surface, and a method with which columnar protrusions are formed on the surface of the formed coating layer by etching or the like, and processing for rounding the ends of the surfaces of columns is performed by blasting processing on the columnar protrusions so as to form a hemispherical protrusion structure having a continuous curvature surface with no angular part formed on the surface.

Further, it is also possible to employ a method of three-dimensional molding by sintering or laser processing using a three-dimensional printer using fine particles of a metal, glass, or ceramics as described in International Publication No. WO 2016190076, for example.

### (Constituent Material of Indentation Forming Member)

### <Base Material>

While there is no specific limit set for the constituent material of the cylindrical base material 6 according to the first embodiment, aluminum, iron, SUS, or the like may be used in a case of the metallic core bar. Further, in a case of forming a resin roll with a resin material, examples of the resin material may be PC (polycarbonate), PI (polyimide), PPS (polyphenylene sulfide), PBT (polybutylene terephthalate), POM (polyacetal), ABS (acrylonitrile-butadiene-styrene copolymer), PS, and PPE, and glass fibers or carbon fibers may also be used together with those.

### (Coating Layer and Protrusions)

It is preferable for the coating layer and the protrusions to be integrally molded preferably with a same material, and it is preferable to select the constituent material from metals, glass, ceramics, and resins.

As the metallic material, there may be aluminum, iron, SUS, and the like that are the same material constituting the base material.

Further, as the glass material, examples may be soda ash glass, borosilicate glass, lead glass, crystalized glass, quartz glass, and the like.

Further, examples of the resin material may be PC (polycarbonate), PI (polyimide), PPS (polyphenylene sulfide), PBT (polybutylene terephthalate), POM (polyacetal), ABS (acrylonitrile-butadiene-styrene copolymer), PS, and PPE, and polyimide is preferable among those in terms of durability (wear resistance).

### (Method for Forming U-shaped Indentations on Fixing Member)

Next, there will be described a method for forming U-shaped indentations on the surface of the fixing member 1 that forms the fixing apparatus by using the cylindrical indentation forming member described above.

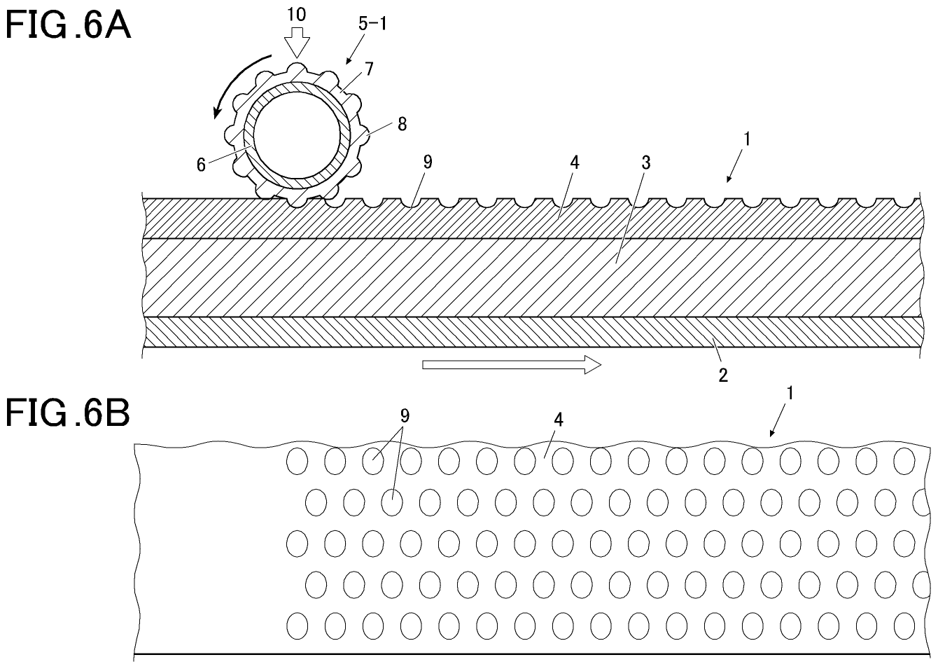

FIG. 6A and FIG. 6B show an example of the method for forming the U-shaped indentations on the surface of the thermoplastic resin layer of the fixing member conveyed continuously by using the roller-type indentation forming member as the first embodiment, in which FIG. 6A is a side view and FIG. 6B is a top view of the fixing member on which the U-shaped indentations are formed.

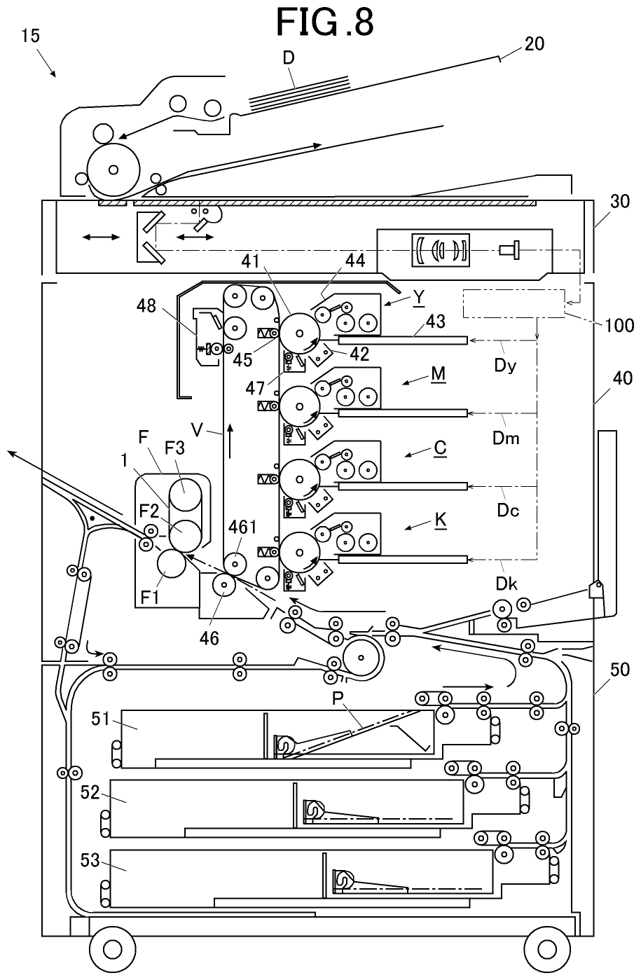

While the entire configuration of the fixing apparatus will be described later by referring to FIG. 8 and FIG. 9, as shown in FIG. 6A, the roller-type indentation forming member 5 having the protrusions 8 formed on the surface thereof shown in FIG. 4A to FIG. 4C is pressed against the surface of the thermoplastic resin layer 4 of the fixing belt 1 that is the continuously conveyed fixing member configured with the base material 2, the elastic layer 3, and the thermoplastic resin layer 4 described by referring to FIG. 1 with a prescribed pressure 10, specifically, with a condition with which the protrusions 8 are completely embedded into the thermoplastic resin layer 4, to continuously form a plurality of U-shaped indentations 9 as shown in FIG. 6B on the surface of the thermoplastic resin layer 4.

At this time, it is preferable for the indentation forming member 5 to be driven or rotationally driven at an equal circumferential speed with respect to the continuously conveyed fixing belt 1 in respect that it is possible to stably form the U-shaped indentations 9 at prescribed positions with high precision.

### Second Embodiment: Endless-Belt Type

As the indentation forming member according to the present invention in another shape, a method for forming the U-shaped indentations on the outermost surface layer by having the seamless-belt type endless belt abutting against the fixing member is one (second embodiment) of the preferred embodiments.

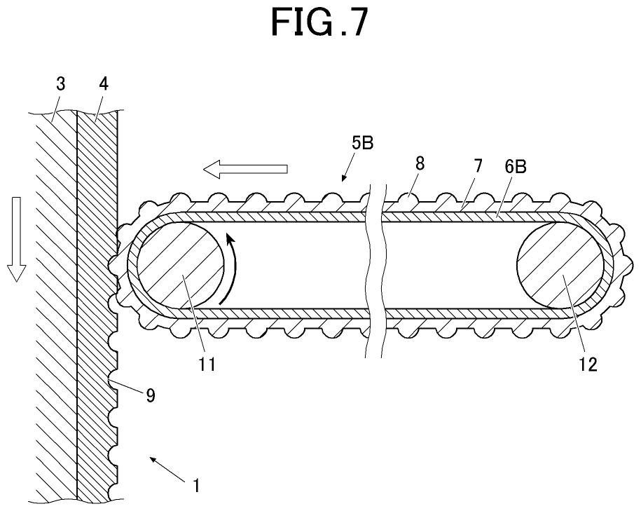

FIG. 7 shows an example of the configuration of the endless-belt type indentation forming member having a hemispherical protrusion structure (second embodiment) according to the present invention and the method for forming the U-shaped indentations.

In FIG. 7, an endless-belt type indentation forming member 5B includes the coating layer 7 on a seamless-belt type base material 6B and a great number of protrusions 8 for forming the U-shaped indentations on the outermost surface layer by applying a pressure on the fixing member.

The endless-belt type indentation forming member 5B is held by a pressure roller 11 and a support roller 12, and rotated in an arrow direction under tension.

In the meantime, the protrusions 8 of the endless-belt type indentation forming member 5B are abutted against the surface of the thermoplastic resin layer 4 of the continuously conveyed fixing belt 1 in the configuration shown in FIG. 1 via the pressure roller 11 to continuously form the U-shaped indentations 9 on the surface of the thermoplastic resin layer 4.

At this time, as for the conveying speed of the endless-belt type indentation forming member 5B, it is preferable to be driven or rotationally driven at an equal circumferential speed with respect to the continuously conveyed fixing belt 1 in respect that it is possible to stably form the U-shaped indentations 9 at prescribed positions with high precision.

### <<Fixing Method>>

Next, an overall outline of an image forming apparatus to which the fixing apparatus of the present invention is mounted as well as the fixing apparatus including the indentation forming member of the present invention mounted thereto will be described.

### [Image Forming Apparatus]

First, the outline of the entire configuration of the typical image forming apparatus will be described by referring to the drawings.

The image forming apparatus that can be applied to the present invention is an electrophotographic image forming apparatus that includes the indentation forming member of the present invention and forms U-shaped indentations on the fixing member to fix a toner image on a recording medium that carries an unfixed toner image by applying heat and pressure.

An example of the typical image forming apparatus will be described by referring to the drawings.

FIG. 8 is a schematic view showing an example of the entire configuration of the image forming apparatus that can be applied to the present invention.

An image forming apparatus 15 shown in FIG. 8 is an intermediate-transfer type color image forming apparatus that utilizes the electrophotographic process technology, and is configured mainly with an automatic document conveyor 20, a scanner 30, an image former 40, a paper feeder 50, a storage (not shown), an operation displayer (not shown), a controller 100, and the like.

The automatic document conveyor 20 configured with a placement tray for placing a document D, a mechanism for conveying the document D, a conveyor roller, and the like, and conveys the document D on a prescribed conveyance path.

The scanner 30 is configured with an optical system such as a light source and a reflection mirror, and irradiates the light source to the document D conveyed along the prescribed conveyance path or the document D placed on platen glass and receives reflected light. Further, the scanner 30 converts the received reflected light into an electric signal and outputs the electric signal to the controller 100.

The image former 40 is configured with an yellow image former Y, a magenta image former M, a cyan image former C, a black image former K, an intermediate transfer belt V, a fixing apparatus F, and the like.

While the image former 40 includes a photosensitive drum 41, a charger 42, an exposure device 43, a developing device 44, a primary transfer roller 45, a secondary transfer roller 46, and the like in addition to those described above, the detailed configuration thereof is not to be described.

As shown in FIG. 8, the fixing apparatus F that includes the fixing member of the present invention is mainly configured with a heating conveyor roller (conveyor roller; F1) disposed under the back side of sheet P, a fixing roller (first roller; F2) disposed on the top face side, a heating roller (second roller; F3) disposed above the fixing roller F2, the fixing belt 1 that is the fixing member according to the present invention, and the like. The fixing apparatus F applies heat and pressure to the sheet P to fix the transferred toner image on the sheet P by letting the sheet P pass through a nip formed by heating and press-fitting the heating conveyor roller F1 and the fixing roller F2, and conveys the sheet P to a downstream side of the conveying direction. In the configuration of the fixing apparatus F, the indentation forming member according to the present invention for forming U-shaped indentations is disposed on the fixing belt 1 as the fixing member at a desired position of the fixing belt 1. Details thereof will be described later by referring to FIG. 9 and FIG. 10A to FIG. 10C.

The heating conveyor roller F1 is formed in a cylindrical form with rubber, and includes a high-output heater inside thereof like the heating roller F3. The heating conveyor roller F1 rotates in a forward direction with respect to the conveying direction of the sheet P, and applies heat and pressure on a non-fixing face of the conveyed sheet P.

The fixing apparatus including the fixing member and the indentation forming member of the present invention can be formed in the same manner as that of a known fixing apparatus that has the configuration corresponding to the form of the fixing member. For example, when the fixing member is the fixing belt, the fixing apparatus is preferable to be in a configuration to utilize it, that is, preferable to have a known configuration capable of implementing biaxial tension belt fixing, pad pressure belt fixing, IH belt fixing, or the like.

For the details of the image forming apparatus that can be applied to the present invention, it is possible to refer to the image forming apparatuses and the fixing apparatuses described in JP 2017-173445A, JP 2017-194550A, JP 2018-4714A, JP 2018-5016A, JP 2018-25691A, JP 2018-25691A, JP 2018-36449A, JP 2018-36587A, JP 2018-54758A, and JP 2018-66768A, for example.

### [Fixing Apparatus A: First Embodiment]

Next, the entire configuration of the fixing apparatus F that includes the fixing member and the indentation forming member will be described by referring to the drawings.

FIG. 9 shows an example of the configuration of the fixing apparatus F including the roller-type indentation forming member 5 (first embodiment) in the image forming apparatus 15 described by referring to FIG. 8.

As described by referring to FIG. 8, the fixing apparatus F shown in FIG. 9 is configured with the heating conveyor roller (conveyor roller; F1), the fixing roller (first roller; F2) disposed on the top face side, and the heating roller (second roller; F3) disposed above the fixing roller F2, and the fixing belt 1 is suspended between the first roller F2 and the second roller F3.

In the meantime, the toner image T formed on the recording medium P is conveyed toward the arrow direction (right direction when facing the sheet) and pressured/heated while passing through the nip B formed between the conveyor roller F1 and the first roller F2 so that the fixing belt 1 meets the toner image face. Thereby, the toner image T is fixed on the recording medium P.

With the fixing method of the present invention, the indentation forming member 5 having the hemispherical protrusion structure according to the present invention and the support roller 13 are disposed at a position corresponding thereto in a form of sandwiching the fixing belt 1 on the upstream side of the position of the nip B, and the indentation forming member 5 is press-fitted on the fixing belt 1 by the method described by referring to FIG. 6A and FIG. 6B to form the U-shaped indentations 9 on the thermoplastic resin layer (not shown) that configures the fixing belt. The fixing belt 1 on which the U-shaped indentations 9 are formed fixes the toner image T on the recording medium P in a fixing area of the nip B. By applying the fixing apparatus of the present invention, it is possible to achieve fine separability between the fixing belt (fixing member 1) and the toner image T after the fixing processing.

In the present invention, as shown in FIG. 9, the indentation forming member 5 is preferable to be constantly press-fitted to the fixing belt 1. Further, it is also possible to employ a method with which the indentation forming member 5 has a function capable of switching between press-fitting to and isolating from the fixing belt 1, and the indentation forming member 5 and the fixing belt 1 are press-fitted when it is required to form the U-shaped indentations 9. Each of such methods may be selected as necessary.

Next, the mechanism for improving the separability of the toner image and the fixing belt 1 with the image forming method using the fixing apparatus of the present invention will be described by referring to the drawings.

FIG. 10A, FIG. 10B, and FIG. 10C are schematic views for describing the effect of separability in the fixer of the first embodiment.

FIG. 10A is a drawing showing a state of the fixing belt 1 and the toner image T held on the recording medium P at the position indicated by “a” of the nip B in FIG. 9 described above. At this stage, it is right before the fixing belt 1 meets the toner image T, and the shape of the U-shaped indentations 9 are being kept in the fixing belt 1.

Then, at the position indicated by “b” in the nip B of FIG. 9 described above, the U-shaped indentations 9 formed in the fixing belt 1 are pressed by the conveyor roller F1 and the first roller F2 to lose the shape thereof due to the effect of the elastic layer 3, so that the thermoplastic resin layer 4 of the fixing belt 1 tightly contacts with the toner image T. Thereby, excellent fixability can be achieved.

Then, shifting to the position indicated by “c” in the nip B shown in FIG. 9 after the toner is completely fixed, the pressure in the nip is released so that the U-shaped indentations 9 of the fixing belt 1 are restored as shown in FIG. 10C. As a result, the contact area with the toner image T is decreased, so that the fixing belt 1 and the toner image T can be separated more stably, thereby making it possible to acquire fine separability (releasability) and to acquire a high-quality toner image with no scars or the like.

### [Fixing Apparatus B: Second Embodiment]

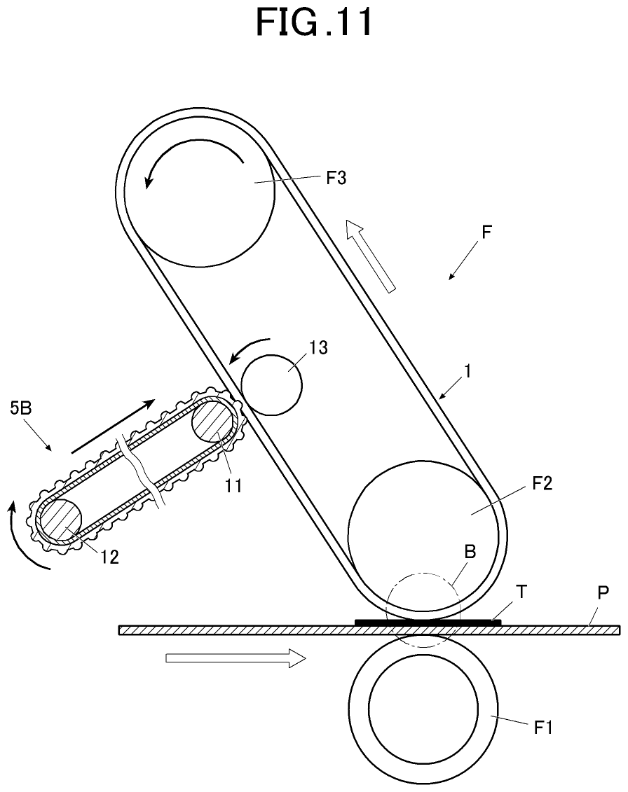

FIG. 11 shows an example of the configuration of the fixing apparatus including the endless-belt type indentation forming member 5B (second embodiment) whose example is shown in FIG. 7, which is applied to the image forming apparatus shown in FIG. 8.

As described by referring to FIG. 8, the fixing apparatus F shown in FIG. 11 is configured with the heating conveyor roller (conveyor roller; F1), the fixing roller (first roller; F2) disposed on the top face side, and the heating roller (second roller; F3) disposed above the fixing roller F2, and the fixing belt 1 is suspended between the first roller F2 and the second roller F3.

In the meantime, the toner image T formed on the recording medium P is conveyed toward the arrow direction (right direction when facing the sheet) and pressured/heated while passing through the nip B formed between the conveyor roller F1 and the first roller F2 so that the fixing belt 1 meets the toner image face. Thereby, the toner image T is fixed on the recording medium P.

With the fixing method of the present invention, the indentation forming member 5B having the hemispherical protrusion structure according to the present invention and the support roller 13 are disposed at a position corresponding thereto in a form of sandwiching the fixing belt 1 on the upstream side of the position of the nip B, and the indentation forming member 5B is press-fitted on the fixing belt 1 by the method described by referring to FIG. 7 to form the U-shaped indentations 9 on the thermoplastic resin layer (not shown) that configures the fixing belt 1. The fixing belt 1 on which the U-shaped indentations 9 are formed fixes the toner image T on the recording medium P in a fixing area of the nip B. By applying the fixing apparatus of the present invention, it is possible to achieve fine separability between the fixing belt (fixing member 1) and the toner image T after the fixing processing.

In the present invention, as shown in FIG. 11, the indentation forming member 5B is preferable to be constantly press-fitted to the fixing belt 1. Further, it is also possible to employ a method with which the indentation forming member 5B has a function capable of switching between press-fitting to and isolating from the fixing belt 1, and the indentation forming member 5B and the fixing belt 1 are press-fitted when it is required to form the U-shaped indentations 9. Each of such methods may be selected as necessary.

### <<Toner>>

The fixing member of the present invention is used for fixing the toner image in the electrophotographic image forming apparatus.

There is no specific limit set for static latent image toner (hereinafter, simply referred to as “toner”) that can be applied to the present invention as long as wax is contained therein as a release agent. For example, the toner is configured with a binder resin, a colorant, a charge control agent, an external additive, and the like in addition to the wax (release agent).

The toner that can be applied to the present invention may be a one-component developer as toner particles configured with toner base particles and the external additive attached on the surfaces thereof or may be a two-component developer containing toner particles and carrier particles carrying those.

For the detailed configuration of the toner that can be applied to the present invention and a manufacturing method thereof, it is possible to refer to the contents described in JP 2018-155912A, JP 2018-180279A, JP 2018-205642A, JP 2019-003101A, JP 2019-015924A, JP 2019-015977A, and JP 2019-035906A, for example.

### Examples

While the present invention will be described in a specific manner by referring to Examples hereinafter, the present invention is not limited thereto. Note that “parts” or “%” used in Examples indicates “parts by mass” or “mass %” unless noted otherwise. Further, each operation was conducted at a room temperature (25° C.) unless noted otherwise.

### <<Fabrication of Fixing Belt>>

Varnish containing a polyamic acid and 8 mass % of carbon black with respect thereto was rotationally applied to the outer side of a cylindrical mold, then dried at 300 to 450° C. for imidization to fabricate a cylindrical polyimide tubular member (base material belt) with 99 mm in inner diameter, 360 mm in length, and 70 μm in thickness. The polyamic acid is a polymer acquired by dehydration condensation of 3,3′,4,4′-biphenyltetracarboxylic dianhydride with p-phenylenediamine.

Then, a stainless cylindrical core bar with external diameter of 99 mm was tightly fitted to the inner side of the base material belt and a cylindrical mold holding a PFA tube with thickness of 30 μm on the inner circumferential face thereof was covered over the outer side of the base material belt to hold the core bar and the cylindrical mold coaxially in the manner described above while forming a cavity between the both. Thereafter, a silicone rubber material was injected into the cavity and cured by heat to fabricate an elastic layer with thickness of 200 μm made of the silicone rubber.

Rubber hardness (type A) of the silicone rubber is 30 degrees, tensile strength is 1.5 MPa, thermal conductivity is 0.7 W/(m K), and elongation is 250%.

### <<Indentation Forming Member>>

### [Fabrication of Indentation Forming Member 1]

A roller-type indentation forming member 1 in the configuration shown in FIG. 4A and FIG. 4C was fabricated according to the following method shown in FIG. 5A and FIG. 5B.

An aluminum core bar 6 (hollow structure with 370 mm in length, 5 mm in thickness, and 22 mm in diameter) was prepared, a metallic mask M thicker than the core bar 6 by 2 mm in the diameter was covered over with the core bar being the center to place a bottom cover. Elliptic recessed structures with 15 μm in depth and 100 μm in width were disposed regularly on the metallic mask M at an interval of 200 μm.

Then, as shown in FIG. 5A, a polyamic acid (a polymer acquired by dehydration condensation of 3,3′,4,4′-biphenyltetracarboxylic dianhydride with p-phenylenediamine) was injected into the gap between the mask M and the core bar 6 as the forming material of the protrusions 8 and the coating layer 7, and heated to be dried at 350° C. for imidization to form a coating layer made of polyimide.

Then, the metallic mask M was removed to fabricate the cylindrical indentation forming member 1 in the configuration shown in FIG. 5B. On the surface of the coating layer 7 of the indentation forming member 1, elliptical hemispheric protrusions 8 with height H of 15 μm and width W of 100 μm are disposed at an interval G of 200 μm in a plurality of lines regularly as shown in FIG. 4B.

### [Fabrication of Indentation Forming Member 2]

An indentation forming member 2 was fabricated in the same manner as that of the indentation forming member 1 except that, in the mask M, elliptic recessed structures with 10 μm in depth and 50 μm in width were disposed regularly at an interval of 100 μm.

On the surface of the coating layer 7 of the fabricated indentation forming member 2, elliptical hemispheric protrusions 8 with the height H of 10 μm and the width W of 50 μm are disposed at the interval G of 100 μm in a plurality of lines regularly as shown in FIG. 4C.

### [Fabrication of Indentation Forming Member 3]

An aluminum core bar 6 (hollow structure with 370 mm in length, 5 mm in thickness, and 22 mm in diameter) was prepared, a metallic mold thicker than the core bar 6 by 2 mm in the diameter was covered over with the core bar being the center to place a bottom cover. Elliptic recessed structures with 10 μm in depth and 50 μm in width were disposed regularly on the metallic mold at an interval of 100 μm.

Then, as shown in FIG. 5A, molten aluminum as the same material with the core bar 6 was injected into the gap between the metallic mold and the core bar 6 as a forming material of the protrusions 8 and the coating layer 7 and solidified and, thereafter, the metallic mold was removed to fabricate the indentation forming member 3 with a single aluminum material in the configuration shown in FIG. 4B. After fabricating the indentation forming member 3, precision polishing was performed on the surface thereof.

On the surface of the fabricated indentation forming member 3, elliptical hemispheric protrusions 8 with the height H of 10 μm and the width W of 50 μm made of aluminum are disposed at the interval G of 100 μm in a plurality of lines regularly as shown in FIG. 4C.

### [Fabrication of Indentation Forming Member 4]

An indentation forming member 4 was fabricated in the same manner as that of the indentation forming member 1 except that, in the mask M, hemispherical recessed structures with 15 μm in depth and 15 μm in width were disposed regularly at an interval of 50 μm.

On the surface of the coating layer 7 of the fabricated indentation forming member 4, hemispherical protrusions 8 with the height H of 15 μm and the width W of 15 μm are disposed at the interval G of 50 μm in a plurality of lines regularly as shown in FIG. 4C.

### [Fabrication of Indentation Forming Member 5]

An indentation forming member 5 was fabricated in the same manner as that of the indentation forming member 1 except that, in the mask M, quadrangular pyramidal recessed structures with 10 μm in depth and 50 μm in width were disposed regularly at an interval of 100 μm.

On the surface of the coating layer 7 of the fabricated indentation forming member 5, quadrangular pyramidal protrusions 8 with the height H of 10 μm and the width W of 50 μm are disposed at the interval G of 100 am in a plurality of lines regularly as shown in FIG. 4C.

### [Fabrication of Indentation Forming Member 6]

An endless-belt type indentation forming member 6 in the configuration shown in FIG. 7 was fabricated.

A stainless cylindrical core bar with 33 mm in external diameter was tightly fitted with the inner side of a belt-like base material made of a polyimide resin with 33 mm in internal diameter, 120 mm in length, and 70 μm in thickness. Then, a cylindrical mold in which elliptical recessed structures with 15 μm in depth and 100 μm in width were disposed regularly at an interval of 200 μm was covered over the outer side of the belt base material to hold the core bar and the cylindrical mold coaxially in the manner described above while forming a cavity (gap) between the both. Thereafter, a polyamic acid (a polymer acquired by dehydration condensation of 3,3′,4,4′-biphenyltetracarboxylic dianhydride with p-phenylenediamine) was injected into the cavity, heated to be dried at 350° C. for imidization to form a coating layer and protrusions made of polyimide.

The indentation forming member 6 was made of a single polyimide material.

On the surface of the coating layer of the indentation forming member 6, elliptical hemispheric protrusions 8 made of polyimide with the height H of 15 μm and width W of 100 μm are disposed at the interval G of 200 μm in a plurality of lines regularly as shown in FIG. 7.

### [Fabrication of Indentation Forming Member 7]

An indentation forming member 7 was fabricated in the same manner as that of the indentation forming member 6 except that, in the mask M, elliptic recessed structures with 10 μm in depth and 50 μm in width were disposed regularly at an interval of 100 μm.

On the surface of the coating layer 7 of the fabricated indentation forming member 7, elliptical hemispheric protrusions 8 made of polyimide with the height H of 10 μm and the width W of 50 μm are disposed at the interval G of 100 μm in a plurality of lines regularly as shown in FIG. 4C.

### <<Fabrication of Fixing Apparatus>>

### [Fixing_Apparatus 1]

According to a known method, a fixing apparatus was formed to have the configuration shown in FIG. 9 with the heating conveyor roller (conveyor roller; F1), the fixing roller (first roller; F2) disposed on the top face side, and the heating roller (second roller; F3) disposed above the fixing roller F2, and the fixing belt having the fabricated thermoplastic resin layer on the outermost surface layer was suspended between the first roller F2 and the second roller F3.

In the thus configured fixing apparatus, the fabricated indentation forming member 1 was disposed on the upstream side of the nip B while being held by a support roll to fabricate a fixing apparatus 1 including the roller-type indentation forming member.

### [Fabrication of Fixing Apparatuses 2 to 5]

Fixing apparatuses 2 to 5 were fabricated in the same manner as that of the fixing apparatus 1 except that the indentation forming member 1 was changed with respective indentation forming members 2 to 5.

### [Fixing Apparatus 6]

According to a known method, a fixing apparatus was formed to have the configuration shown in FIG. 11 _with the heating conveyor roller (conveyor roller; F1), the fixing roller (first roller; F2) disposed on the top face side, and the heating roller (second roller; F3) disposed above the fixing roller F2, and the fabricated fixing belt having the thermoplastic resin layer on the outermost surface layer was suspended between the first roller F2 and the second roller F3.

In the thus configured fixing apparatus, the fabricated indentation forming member 6 was disposed on the upstream side of the nip B while being held by a support roll to fabricate a fixing apparatus 6 including the endless-belt type indentation forming member 6.

### [Fabrication of Fixing Apparatus 7]

A fixing apparatus 7 was fabricated in the same manner as that of the fixing apparatus 6 except that the indentation forming member 6 was changed with an indentation forming member 7.

### [Fabrication of Fixing Apparatus 8]

A fixing apparatus 8 was fabricated in the same manner as that of the fixing apparatus 1 except that the indentation forming member 1 was eliminated.

<<Fabrication of Image forming Apparatus>>

### [Image Forming Apparatus 1]

The fixing apparatus 1 including the fabricated indentation forming member 1 was used for the fixing apparatus in a full-color copying machine “bizhub PRESS C1070” (manufactured by Konica Minolta Inc.) to fabricate an image forming apparatus 1 that forms an image by forming U-shaped indentations on the fixing belt by employing a driving method (referred to as a driving method A) with which the roller-type indentation forming member 1 is driven by following the speed of the fixing belt.

### [Image Forming Apparatuses 2 to 4]

Image forming apparatuses 2 to 4 were fabricated in the same manner as that of the image forming apparatus 1 except that respective fixing apparatuses 2 to 4 were used instead of the fixing apparatus 1.

### [Image Forming Apparatus 5]

In the same manner as that of the image forming apparatus 2, there was formed an image forming apparatus 5 that forms an image by forming U-shaped indentations on the fixing belt by employing a driving method (referred to as a driving method B) with which the roller-type indentation forming member 2 is driven at an equal circumferential speed with respect to the speed of the fixing belt.

### [Image Forming Apparatus 6]

In the same manner as that of the image forming apparatus 2, there was formed an image forming apparatus 6 that forms an image by forming U-shaped indentations on the fixing belt by employing a driving method (referred to as a driving method C) with which the roller-type indentation forming member 2 is driven at a rotation speed of +10% with respect to the speed of the fixing belt.

### [Image Forming Apparatus 7]

In the same manner as that of the image forming apparatus 2, there was formed an image forming apparatus 7 that forms an image by forming U-shaped indentations on the fixing belt by employing a driving method (referred to as a driving method D) with which the roller-type indentation forming member 2 is driven at a rotation speed of −10% with respect to the speed of the fixing belt.

### [Image Forming Apparatuses 8 to 11]

Image forming apparatuses 8 to 11 were fabricated in the same manner as that of the image forming apparatus 1 except that respective fixing apparatuses 5 to 8 were used instead of the fixing apparatus 1.

### <<Evaluation of Images Formed by Image Forming Apparatuses>>

Images were outputted by each of the fabricated image forming apparatuses, and following evaluations were conducted.

### [Evaluation of Separability]

While a device for blowing air between the tip of the recording medium and the fixing belt in the outlet of the nip was provided to the copying machine “bizhub PRESS C1070” as a separation assisting device, it was invalidated at the time of the evaluations of separability.

### (Evaluations of Initial Separability)

Color Copy sheet (basis weight: 90 g/m2) manufactured by Mondi Limited was used as A4 plain sheet and a solid image (red) in two layers of cyan and magenta having arbitrary margin of 1 mm-pitch in the edge of the image was outputted as an output image, and the head margin with which the sheet can be fed without clinging to the fixing belt was acquired.

AA: Sheet can be fed without clinging of the solid image with the head margin of 2 mm or less

BB: Sheet can be fed without clinging of the solid image with the head margin of over 2 mm and 4 mm or less, so that there is no problem for actual use

CC: Sheet cannot be fed due to clinging of the solid image with the head margin of 4 mm or less

(Evaluations of Separability after Continuous Printing)

After continuously printing each monochrome image of Y, M, C, and Bk as 10% strip-like image on 1000 pieces of A4 plain sheet (J sheet manufactured by Konica Minolta Inc.) by using each of the image forming apparatuses, separability with the fixing belt was evaluated in the same manner as those of evaluation method and evaluation ranks of the initial separability.

### (Evaluations of Image Roughness)

After continuously printing each monochrome image of Y, M, C, and Bk as 10% strip-like image on 1000 pieces of A4 plain sheet (J sheet manufactured by Konica Minolta Inc.) by using each of the image forming apparatuses, solid images of cyan were outputted by using “POD Gloss Coat 128” manufactured by Oji Paper Co., Ltd. as the sheet, and evaluations of image roughness were conducted on the acquired solid images of cyan according to the following evaluation criteria.

AA: Uniform solid image with no recognized remnants caused due to the protrusion structure of the indentation forming member

CC: Non-uniform solid image with recognized remnants caused due to the protrusion structure of the indentation forming member

Table 1 shows the results acquired in the manner described above.

### [Table 1]

TABLE I

| | | | | | | | | | Evaluation results | | | |
|---|---|---|---|---|---|---|---|---|---|---|---|---|
| No. of | | Indentation forming members | | | | | | | | | Image | |
| Image | No. of | | | Protrusion structures | | | | | Separability | | roughness | |
| forming | Fixing | | | | Constituent | Width | Height | | | After | after | |
| appara- | appara- | | Form of | Protrusion | material of | W | H | Driving | Initial | printing | printing | |
| tuses | tuses | No. | Member | shape | Protrusions | [μm] | [μm] | method | state | 1000 pcs | 1000 pcs | Remarks |
| 1 | 1 | 1 | Roller | Elliptical | Polyimide | 100 | 15 | A | AA | AA | AA | Present |
| | | | type | hemisphere | | | | | | | | invention |
| | | | (FIG. 9) | | | | | | | | | |
| 2 | 2 | 2 | Roller | Elliptical | Polyimide | 50 | 10 | A | AA | AA | AA | Present |
| | | | type | hemisphere | | | | | | | | invention |
| | | | (FIG. 9) | | | | | | | | | |
| 3 | 3 | 3 | Roller | Elliptical | Metal (Al) | 50 | 10 | A | AA | AA | AA | Present |
| | | | type | hemisphere | | | | | | | | invention |
| | | | (FIG. 9) | | | | | | | | | |
| 4 | 4 | 4 | Roller | Hemisphere | Polyimide | 15 | 15 | A | AA | AA | AA | Present |
| | | | type | | | | | | | | | invention |
| | | | (FIG. 9) | | | | | | | | | |
| 5 | 2 | 2 | Roller | Elliptical | Polyimide | 50 | 10 | B | AA | BB | AA | Present |
| | | | type | hemisphere | | | | | | | | invention |
| | | | (FIG. 9) | | | | | | | | | |
| 6 | 2 | 2 | Roller | Elliptical | Polyimide | 50 | 10 | C | AA | BB | AA | Present |
| | | | type | hemisphere | | | | | | | | invention |
| | | | (FIG. 9) | | | | | | | | | |
| 7 | 2 | 2 | Roller | Elliptical | Polyimide | 50 | 10 | D | AA | BB | AA | Present |
| | | | type | hemisphere | | | | | | | | invention |
| | | | (FIG. 9) | | | | | | | | | |
| 8 | 5 | 5 | Roller | Quadrangular | Polyimide | 50 | 10 | A | AA | CC | AA | Comparative |
| | | | type | pyramid | | | | | | | | example |
| | | | (FIG. 9) | | | | | | | | | |
| 9 | 6 | 6 | Endless- | Elliptical | Polyimide | 100 | 15 | A | AA | AA | AA | Present |
| | | | belt type | hemisphere | | | | | | | | invention |
| | | | (FIG. 11) | | | | | | | | | |
| 10 | 7 | 7 | Endless- | Elliptical | Polyimide | 50 | 10 | A | AA | AA | AA | Present |
| | | | belt type | hemisphere | | | | | | | | invention |
| | | | (FIG. 11) | | | | | | | | | |
| 11 | 8 | — | — | — | — | — | — | — | CC | CC | AA | Comparative |
| | | | | | | | | | | | | example |

A: Driven by following speed of fixing belt
B: Driven at equal circumferential speed with fixing belt
C: Driven at +10% of circumferential speed of fixing belt
D: Driven at −10% of circumferential speed of fixing belt

As can be seen from the results shown in Table I, it is found that the fixing apparatus that includes the indentation forming member having the protrusion structure according to the present invention exhibits excellent separability between the fixing belt and the toner image at the initial state and even after executing continuous printing, and is capable of acquiring stable high-quality toner images.

Although embodiments of the present invention have been described and illustrated in detail, the disclosed embodiments are made for purposes of illustration and example only and not limitation. The scope of the present invention should be interpreted by terms of the appended claims

What is claimed is:

1. A fixing apparatus comprising a fixing member, wherein
the fixing member includes a thermoplastic resin layer as an outermost surface layer; and
the fixing apparatus includes an indentation forming member having a protrusion structure with no angular part formed on a surface for forming U-shaped indentations on the outermost surface layer by applying pressure on the fixing member.

2. The fixing apparatus according to claim 1, wherein a resin that forms the thermoplastic resin layer is at least a fluorine-based resin.

3. The fixing apparatus according to claim 1, wherein the fixing member at least includes a base material, an elastic layer, and the thermoplastic resin layer in this order.

4. The fixing apparatus according to claim 1, wherein the indentation forming member is a rotation member.

5. The fixing apparatus according to claim 1, wherein the protrusion structure with no angular part formed on the surface provided to the indentation forming member is a hemispherical protrusion structure.

6. The fixing apparatus according to claim 1, wherein the surface of the indentation forming member is formed with a material selected from metals, glass, ceramics, and resins.

7. The fixing apparatus according to claim 1, wherein the indentation forming member is driven or rotationally driven at an equal circumferential speed with respect to the fixing member that is being conveyed.

8. The fixing apparatus according to claim 7, wherein the indentation forming member is constantly press-fitted to the fixing member.

9. The fixing apparatus according to claim 7, wherein the indentation forming member has a function capable of switching between press-fitting to and isolating from the fixing member.

10. A fixing method that fixes a toner image by using the fixing apparatus according to claim 1.
